(19) United States
(12) Patent Application Publication
(10) Pub. No.: US 2017/0034330 A1
(43) Pub. Date: Feb. 2, 2017

(54) Method and Device to Operate Phone with a Single Key

(71) Applicant: Rui Zhang, College park, MD (US)

(72) Inventors: Yimin Zhang, Qingdao (CN); Rui Zhang, Qingdao (CN)

(21) Appl. No.: 15/283,455

(22) PCT Filed: Mar. 30, 2015
(86) PCT No.: PCT/CN2015/000217

§ 371 Date: Oct. 3, 2016

(30) Foreign Application Priority Data
Apr. 3, 2014 (CN) 201410132777.3

(51) Int. Cl. H04M 1/725; H04M 1/2745; H04M 7/12; H04M 3/44

(52) U.S. Cl. CPC H04M 1/7258; H04M 3/44; H04M 1/274533; H04M 7/1295; H04M 1/72541

(57) ABSTRACT

The present invention discloses a method to operate phone using a single key, first provide method to form ‘key value’: (1) When the key is just closed, plus 1 to the ‘key value’, (2) When the key closing time is greater than time t1, form ‘closing key value’, (3) When the key closing time is smaller than t1 and the immediate key releasing time is greater than t2, store the key value as ‘releasing key value’, (4) When the key closing time is smaller than t1 and the immediate key releasing time is smaller than t2, skip to step (1). The ‘releasing key values’ can be used to represent the numerical and alphabetical keys on typical keypad of phone, while the ‘closing key values’ can be used to represent the function key on typical keypad of phone, so that the complete function of a typical phone keypad can be realized using only one key. Therefore, a phone can be made very small, which can be especially useful when installed on small Bluetooth device that connects to phone, since not only can it answer incoming phone calls, but also making outgoing phone calls.

### BACKGROUND OF THE INVENTION

1. Field of the Invention

The present invention relates generally to the field of communication devices with a single operation key. More specifically, this method and apparatus relates to the wireless/wired communication between mobile phone and other external device, through Bluetooth and etc., by dialing with a single key.

2. Description of the Prior Art

In the existing phone dialing system, allocation of different function to one key is realized through varying the time for which the key is being pressed down. For example, a shortcut can be imposed on a key by setting a time limit for which when exceeded, a prestored phone number will be dialed instead of the printed value on the key. However, this approach limits the number of statues that can be allocated to one key, so that the basic function set of a typical phone keypad cannot be realized through one key. For instance, a small Bluetooth earphone can only answer phone calls but cannot dial, while a Bluetooth watch that can dial, cannot be made small. Therefore, conventional methods of dialing either require the memorization or the visual search of contact numbers. This is typically accompanied by the need to operate small keypad, which can be inconvenient for the elderlies, the children, the disabled and the injured, where mistakes can be easily made.

### SUMMARY OF THE INVENTION

In order to overcome the shortcomings existing in the prior art, the present invention provides a method to operate phone using a single key and a device to implement it, so that the functions of a typical phone can be realized through a single key with a simple structure and convenient operation. The present invention also eliminates the potential danger due to prolonged dialing time in case of emergency, which is particularly useful for monitoring children and patients with insufficient self-control and capability.

In order to realize the above purpose, the invention adopts the following technical solution:

A method and device of single-key dial, where the method is realized with one key through the following steps:

(1) when the key is just closed, plus 1 to the ‘key value’,

(2) judging if the key closing time is less than t1, if yes, skip to step (3); otherwise, skip to step (4);

(3) judging if the key releasing time is less than t2, if yes, skip to step (1); otherwise, store the key value as the ‘releasing key value’, exit the key value forming process, and execute the ‘releasing key value processing procedure’;

(4) store the ‘key value’ as the ‘closing key value’, exits the key value forming process, and executes the ‘closing key value processing procedure’;

(5) the key statues becomes idle, the key value is set to zero.

Furthermore, in step (1), each time when the key is pressed, a prompt tone corresponding to the stored phone number associated with the ‘key value’ will be played once. In step (3), when dialing the phone number associated with the ‘releasing key value’, each time when the key is pressed, a prompt tone corresponding to the stored phone number associated with the ‘releasing key value’ will be played once. In the case where no pressing of the key is detected within time t2 after a prompt tone is played, a call will be made automatically to the phone number corresponding to the last prompt tone played; in the case where pressing of the key is detected within time t2 after a prompt tone is played, a prompt tone corresponding to the stored phone number associated with the updated ‘key value’ or ‘releasing key value’ will be played. This procedure will be repeated until the desired contact number is reached. This method utilizes prompt tones to search for contact number, therefore, neither the memorization nor the visual search of contact numbers is required. The user only needs to either remember how many times to press the key to dial each contact number, or rely on help of the prompt tone. The prompt tones described can be either audio records or digital synthesized sounds. The one key that is required in the present invention can be installed on a mobile phone or any other device that is connected to the mobile phone through Bluetooth and etc.

Furthermore, considering real life applications, the present invention preferably selects selects t1=1.7 s, t2=1.7 s, but these can be adjusted according to the specific reaction time of the users.

Furthermore, the said ‘releasing key value processing procedure’ in step (3) includes the following steps:

(3.1) judging whether the device is under editing mode, if yes, ‘releasing key value’ is a integer ranges from 1 to 12, corresponding to the keypad values of 1, 2, 3, 4, 5, 6, 7, 8, 9, 0, #, and ‘dial/answer’ key on typical phone; The judging of editing mode includes but is not limited to the following steps:
(3.1.1) judging whether the phone is under calling mode, if yes, send the dual-tone multi-frequency signal corresponding to the ‘releasing key value’,
(3.1.2) judging whether the ‘releasing key value’ corresponds to the ‘dial’ key, if yes, dial the previous value stored in the ‘releasing key value’, otherwise, update the stored ‘releasing key value’ to the current value;

(3.2) judging whether the phone is under idle mode and is not under editing mode, if yes, dial the phone number corresponds to the ‘releasing key value’,

(3.3) judging whether the phone is under calling mode, if yes, any ‘releasing key value’ triggers ‘end’ call;

(3.4) judging whether the phone is under the status where dial had been made successfully but nobody is answering, if yes, any ‘releasing key value’ triggers ‘end’ call;

(3.5) judging whether the phone is under ‘ringing’ mode, if yes, ‘releasing key value’ equals 1 triggers ‘answer’ call, while ‘releasing key value’ equals 2 triggers ‘end’ call;

the editing mode described above refers to the mode under which the ‘releasing key value’ detected is not used to dial the corresponding phone number nor used to ‘end’ call, instead, it is used to store the updated ‘releasing key value’ or used for other purpose.

Furthermore, in step (3.5) when the phone is under ringing mode, if the incoming call is made from a phone number stored in the device, the ringing tone will be the prompt tone corresponds to the said phone number; otherwise, the ringing tone will be a default sound; when determine whether to pick up the call through speech recognition.

Furthermore, step (4) ‘closing key value processing procedure’ includes the following steps:

(4.1) judging whether the phone is under editing mode includes but is not limited to the following steps:
(4.1.1) judging whether the ‘closing key value’ is 2 or 3, if yes, when the ‘closing key value’ is 2, exit editing mode, whereas when the ‘closing key value’ is 3, enter power on\off mode; otherwise, skip to step (4.1.2);
(4.1.2) judging whether the phone is under calling mode and the ‘closing key value’ is neither 2 nor 3, if yes, any ‘closing key value’ that is neither 2 nor 3 triggers the phone to exit editing mode; otherwise, any ‘closing key value’ that is neither 2 nor 3 triggers the phone to exit editing mode and enter the ‘contact numbers and audio records management procedure’;

(4.2) judging whether the phone is under calling mode and is not under editing mode, if yes, enter editing mode when the ‘closing key value’ is 2 and enter power on\off mode when the ‘closing key value’ is 3; otherwise, enter emergency calling mode when the ‘closing key value’ is 1, enter editing mode when the ‘closing key value’ is 2, and enter power on\off mode when the ‘closing key value’ is 3; in the said emergency calling mode, the emergency contact numbers are stored as the first to third phone numbers in the contact list, associated with the ‘key values’ 1 to 3 respectively; in the emergency calling mode, the device will dial the said first through third phone numbers according to the numerical order until a success phone call is made, moreover, a text message seeking for help, for example ‘SOS’, will also be sent to each of the said emergency contact numbers.

Furthermore, each entry in the said contact list contains 3 field where the first field is used to store the entry number that corresponds to the physical location of the said entry in the FLASH memory, the second field is used to store the phone number, and the third field is used to store the audio record of customized prompt tone; in step (4.1.2), the said ‘contact numbers and audio records management procedure’ includes the following steps:

(4.1.2.1) judging whether the ‘closing key value’ is 1 includes but is not limited to the following steps:
(4.1.2.1.1) judging whether there is input to the ‘releasing key value’ before exiting the editing mode, if yes, store the input ‘releasing key value’ as the phone number in the second field of the empty entry in the contact list with the smallest entry number, then start audio recording until the key is released and store in the third field of the said entry;
(4.1.2.1.2) judging whether there is no input to the ‘releasing key value’ before exiting the editing mode and the time elapse after ending an incoming call is shorter than time t3, if yes, store the incoming call phone number in the second field of the empty entry in the contact list with the smallest entry number, then start audio recording until the key is released and store in the third field of the said entry; otherwise, exit ‘contact numbers and audio records management procedure’, then enter idle mode;

(4.1.2.2) judging whether the ‘closing key value’ is larger than 3 includes but is not limited to the following steps:
(4.1.2.2.1) judging whether there is input to the ‘releasing key value’ before exiting editing mode, if yes, store the ‘releasing key value’ as the phone number in the second field of the empty entry in the contact list with the smallest entry number, then start audio recording until the key is released and store in the third field of the said entry;
(4.1.2.2.2) judging whether there is no input to ‘releasing key value’ before exiting editing mode and the time elapse after ending an incoming call is shorter than time t3, if yes, store the incoming call phone number in the second field of the empty entry in the contact list with the smallest entry number, then start audio recording until the key is released and store in the third field of the said entry; otherwise, only start audio recording until the key is released and store in the third field of the entry with entry number equals to the ‘closing key value’ while make no modification to the phone number in the second field of the said entry;

(4.1.2.3) judging whether the input to the ‘releasing key value’ before exit editing mode corresponds to null value, any ‘releasing key value’ that is larger than 12, if yes, exit ‘contact numbers and audio records management procedure’, then enter idle mode.

Furthermore, the present invention preferably selects selects t3 =30 s.

Furthermore, when the phone numbers in the said emergency contact list in step (4) are granted with the permission to control the said phone via SMS, after the phone number in the emergency contact list sends a learning command to the phone via SMS, the phone stores the positioning data of the base station it passes during the learning period in the FLASH memory, and after receiving the SMS of command In, if the phone enters the base station it passes during the learning period, a SMS containing ‘Inside’ will be sent to the phone number of the emergency contact list; after receiving the SMS of command out, if the phone leaves the base station it passes during learning, a SMS containing ‘Outside’ will be sent to the phone number of the emergency contact list;

after the phone receives the query command of location via SMS sent by the phone number of the emergency contact list, the mobile phone will automatically reply with the location of the current base station; after the phone number of emergency contact list set the phone to monitoring mode through SMS, the phone will automatically pick up calls from the said phone number in the emergency contact list.

The present invention also provides a phone with a single key, including CPU, FLASH memory, a key, audio circuitry, GSM module, microphone, speaker, and SIM card, where the said CPU is used for counting the number of times of the key closing and releasing action and the interval, as well as calling and storing the contacts and the recordings in the FLASH memory, driving the GSM module to carry out wireless communication, and controlling the audio circuitry to perform recording and recording playback; the voice signal generated by said microphone will be input into the GSM module after being processed by the power amplifier of the audio circuit and the anti-interference module; the voice signal received by said GSM module will be input into the speaker to carry out voice playback after being processed by the anti-interference module of the audio circuit and the power amplifier; said SIM card and GSM module is connected to provide verification of identification of the network users.

Furthermore, said CPU adopts the ATmega328 chip, said GSM module adopts the SIM900A chip; said anti-interference module is composed with capacitors in parallel and/or in series; each entry in the contact list contains 3 fields, the first field stores the entry number corresponding to the order of the physical locations in the FLASH memory, the second field stores the phone numbers, and the third field stores the recording that is used for the corresponding prompt tone.

Beneficial effects: (1) The invention adopts only a key, dial the phone number of the registration number which the key value corresponds through the number of times of pressing the key, it makes the memory of the long phone numbers to memorize the simple registration number and there is the recording prompt, without the necessity to memorize the phone numbers. (2) For the invention, through simple operation: pressing a key, the mobile phone automatically dial the first 3 phone numbers according to the order, while sending “SOS” SMS to them, thus, when an emergency occurs, such as an unexpected illness, experiencing criminals etc., the mobile phone can be used to ask for help promptly, to increase security. (3) The mobile phones provided by the invention possess the function of prestoring the recording of the contacts, when a call is from the contact the prompt tone is the recording of the contact, when dialing through the number of times of pressing the key, each time pressing the key, the recording of the registration number corresponding the key value will be played once, used to prompt the contact of the key value, which is equivalent of searching the contacts by using the recording, which is convenient and efficient. (4) The invention has the function of “regional recognition” set, the function is very useful for monitoring the patients and the children with insufficient self-control. (5) The invention has the function of voice recognition set, during the ringing of the mobile phone, the CPU recognizes the voice from the microphone, once the voice “Hello” is identified then it picks up, and enters into the speakerphone status. (6) The mobile phones provided by the invention possess only one extra-large key, which will not result in pressing the wrong number like an ordinary mobile phone for the elderly who is not handy and for the children, and particularly useful during the physical discomfort or emotional stress. (7) The invention possesses only a key to operation the mobile phone, the keyboard can be saved; moreover there is the recording prompt for dialing and answering phone calls, the display can be saved; the phone can be made very small, especially the small Bluetooth devices connect with the phone via wireless connection not only can answer phone calls but also can proactively dial phone numbers. (8) The releasing key value can correspond the figure keys and the letter keys of the conventional keyboard, the closing key value can correspond the functional keys of the conventional keyboard, the method allows a key to accomplish the functions of the entire keyboard. The invention makes the phone to be able to use a key to accomplish the following functions: (8.1) Dialing any phone number, (8.2) Quickly dialing the prestored phone number (8.3) Sending dual tone multi-frequency key value signal during phone calls, (8.4) Quickly dialing in cycle 3 prestored phone numbers, (8.5) Prestoring phone numbers and store the prompt recording corresponding the phone number, (8.6) When there is incoming calls, playing the recording corresponding the phone number of the incoming call, (8.7) When dialing the prestored phone numbers, playing the recording corresponding the phone number, (8.8) Positioning of base station, (8.9) Region recognition.

### BRIEF DESCRIPTION OF THE DRAWINGS

FIG. 1 is the flow chart of the method of operating phone with a single key the present invention provides.

FIG. 2 is the flow chart of the closing key value processing procedure the present invention adopts.

FIG. 3 is the flow chart of the releasing key value processing procedure the present invention adopts.

FIG. 4 is the schematic structure of the device of single-key mobile phone the present invention provides.

FIG. 5 is the diagram of the pins of the chip Atmega328 the present invention adopts.

FIG. 6 is the diagram of the pins of the FLASH memory circuit the present invention adopts.

FIG. 7 is the diagram of the pins of the chip SIM900A the present invention adopts.

FIG. 8 is the diagram of the pins of the SIM card the present invention adopts.

FIG. 9 is the diagram of the audio circuitry the present invention adopts.

FIG. 10 is the flow chart of phone numbers and audio records management procedure the present invention adopts.

### DETAILED DESCRIPTION OF THE INVENTION

Method of embodiment:

The following is a further description of the present invention with the aid of drawings.

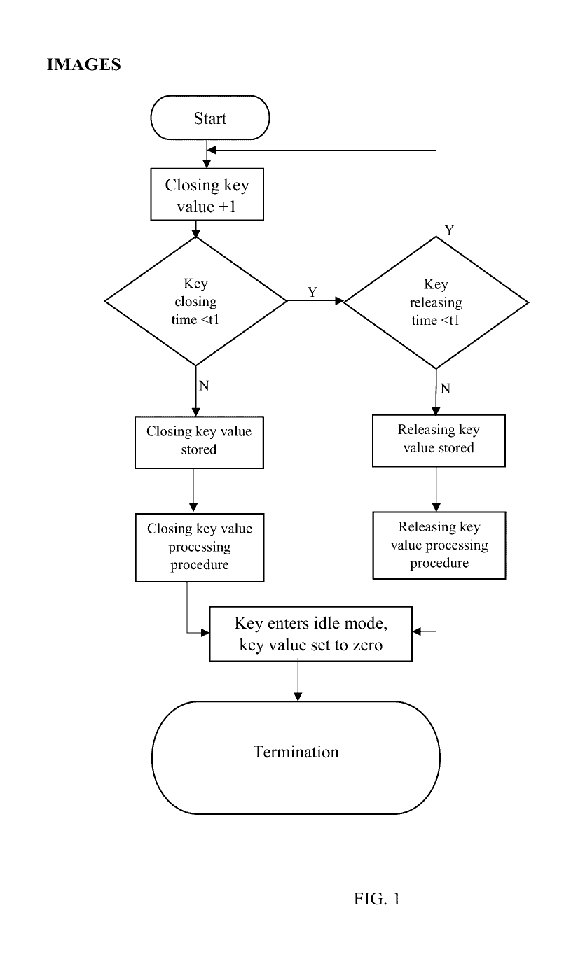

As shown in FIG. 1, the present invention provides a method to operate phone using a single key, including the following steps:
(1) when the key is just closed, plus 1 to the ‘key value’,
(2) judging if the key closing time is less than t1, if yes, skip to step (3); otherwise, skip to step (4);
(3) judging if the key releasing time is less than t2, if yes, skip to step (1); otherwise, store the key value as the ‘releasing key value’, exit the key value forming process and trigger the ‘releasing key value processing procedure’, then when the phone is under idle mode and not under editing mode, dial the number in the contact list that corresponds to the ‘releasing key value’;
(4) store the ‘key value’ as the ‘closing key value’, exit the key value forming process, and trigger the ‘closing key value processing procedure’, then when the phone is not under editing mode nor under calling mode, when ‘closing key value is 1, perform emergency call by dialing the emergency contact phone numbers, the first to third phone number in the contact list, until a success phone call is made, at the same time, send SMS containing ‘SOS’ to the said emergency contact phone numbers;
(5) the key statues enters idle mode and the key value is set to zero.

Wherein, the ‘releasing key values’ corresponds to the numerical keys in typical phones, and ‘closing key values’ corresponds to the function keys in typical phones. The present invention preferably selects t1=t2=1.7 s, and prestore the speech record of the incoming callers corresponding to the contact list in the FLASH memory. When incoming call is made from a number stored in the contact list, the prompt tone will be speech record of the caller; when making phone call through the number of times the key is pressed, each time the key is pressed, the corresponding audio record will be played once to indicate the contact number corresponding to the key value, and if the current prompt tone corresponds to the desired contact to make the call, stop pressing the key after the corresponding prompt tone and the said number will be dialed automatically after 1.7 seconds; else if the current prompt tone does not correspond to the desired contact to make the call, continue to press key within 1.7 seconds until the desired contact is reached.

Each stored phone number occupies 1 entry in the FLASH memory, and each entry includes 3 fields.

The first field: entry number corresponding to the physical location of the said entry in the memory;

the second field: phone number;

the third field: audio record, which is used as the prompt tone of the key during the key value forming period. For example, if the desired number to call is stored in the third entry in the contact list, the key value forming procedure consist of integer key values 1 to 3, when key value is 1, play the audio record of the first entry; when the key value is 2, play the audio record of the second entry; when the key value is 3, play the audio record of the third entry. Releasing the key after time t2 after the audio record is played will form a numerical key with key value of 3. The program automatically dials the phone number in the third entry in the contact list. Therefore, utilizing the prompt tone of speech is similar to searching through a phone book with audio record.

The present invention provides 3 methods to store the phone numbers as following:
(1) Setting through SMS
After enter editing mode (LED indicator available) through function key with key value of 2, send SMS to the phone in the following format: key word: n, m
Key word—now is set to be ‘add’
n—the desired entry number to be used
m—the phone number to be saved

For this method, the audio record field is empty. The method to modify the audio record will be supplemented in the rest of the document.

(2) Setting through caller ID

Enter editing mode within 30 seconds after ending an income call, then press the function key with value n as in foregoing description without releasing, which will trigger the program to store the number of the preceding incoming call to the second field of the entry in the contact list with entry number equals to n, and then start audio recording. The recording ends when the key is released, then the audio record will be saved to the third field of the said entry.

(3) Setting through editing mode

In editing mode, enter the phone number using numerical and function key as in foregoing description. Then press the function key with value n as in foregoing description without releasing, which will trigger the program to store the input phone number to the second field of the entry in the contact list with entry number equals to n, and then start audio recording. The recording ends when the key is released, then the audio record will be saved to the third field of the said entry.

Method to modify audio record: Enter edit mode after making sure that there is no incoming call within the preceding 30 seconds, then press the function key with value n as in foregoing description without releasing, which will trigger the program to start audio recording. The recording ends when the key is released, then the audio record will be saved to the third field of the said entry.

(I) Releasing Key Value Processing Procedure
In the present embodiment, the rules to process releasing key value are as follows:
1: while in ringing mode, releasing key value of 1 signifies pick up call, releasing key value of 2 signifies end call without answering;
2: while in calling mode and not in editing mode, any input releasing key value signifies end call;
3: when number has successfully dialed but has not been picked up yet, any releasing key value signifies end call;
4: while in idle mode and not in editing mode, dial the phone number with entry number corresponding to the releasing key value in the contact list;
5: while in editing mode, releasing key value of 1 to 12 signifies 1, 2, 3, 4, 5, 6, 7, 8, 9, 0, #, and dial/pickup keys respectively;

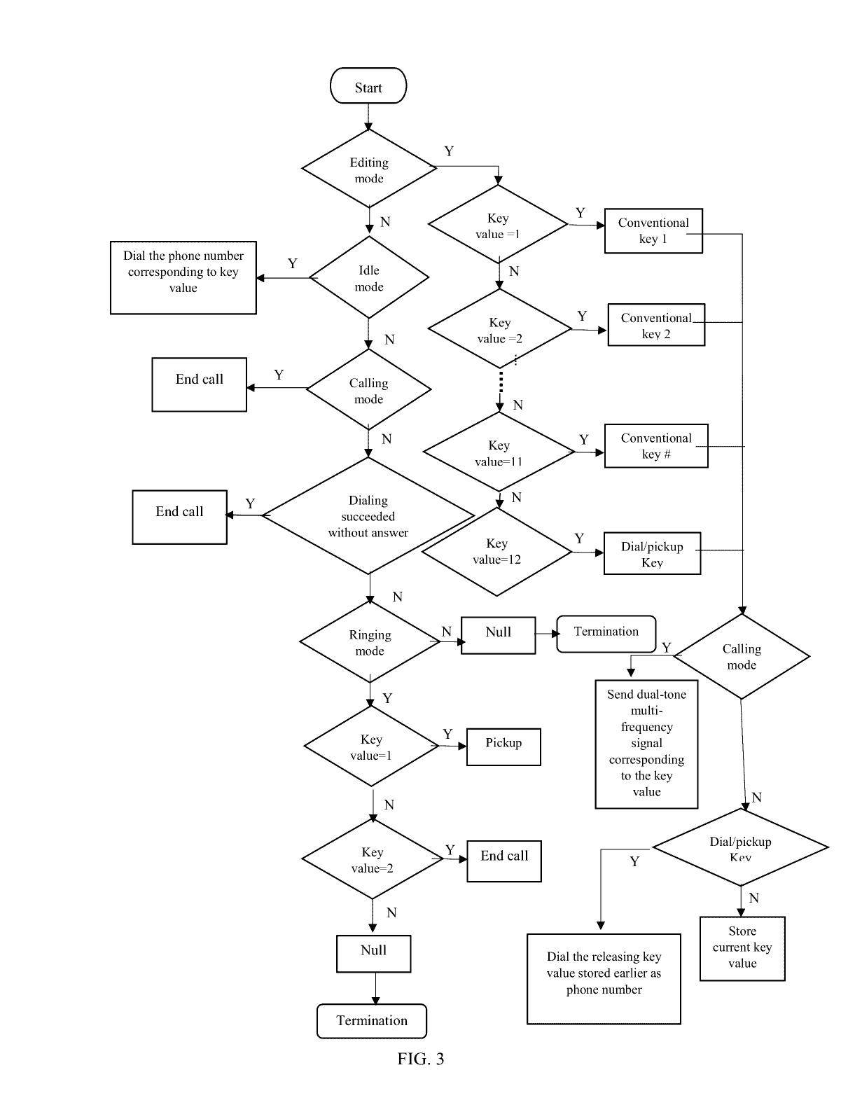

without breaking the above rules, the ‘releasing key value processing procedure’ can be set as desired, while the present invention preferably selects the ‘releasing key value processing procedure’ as shown in FIG. 3:

(31) judging whether the phone is under editing mode, if yes, skip to step (32), otherwise, skip to step (34);

(32) the ‘releasing key value’ is an integer ranging from 1 to 12 which corresponds to the keys 1, 2, 3, 4, 5, 6, 7, 8, 9, 0, #, and ‘dial’ on a typical phone pad, judging whether the phone is under calling mode, if yes, send the dual-tone multi-frequency signal corresponding to the ‘releasing key value’; otherwise, skip to step (33);

(33) judging whether the releasing key value corresponds to the dial/pickup key, if yes, dial the previously stored ‘releasing key value’ as phone number;

(34) judging whether the phone is under idle mode, if yes, dial the phone number in the contact list with entry number corresponding to the ‘releasing key value; otherwise, skip to step (37);

(37) judging whether the phone is under ringing mode, if yes, releasing key value of 1 signifies pick up call, while releasing key value of 2 signifies end call.

(II) Closing Key Value Processing Procedure

In the present embodiment, the rules to process closing key value are as follows:
1: while in editing mode;
   closing key value of 2 signifies exit editing mode;
   closing key value of 3 signifies power on/off function realized through power on/off program;
2: while in editing mode, for closing key value that is neither 2 nor 3 there are two scenarios;
   A: if in calling mode, exit editing mode without any further actions;
   B: if not in calling mode, exit editing mode and enter phone numbers and audio records management procedure;
3: while not in editing mode and in calling mode;
   closing key value of 2 signifies enter editing mode;
   closing key value of 3 signifies power on/off function realized through power on/off program;
   closing key value that is neither 2 nor 3 signifies null value;

4: while neither in editing mode nor calling mode;
closing key value of 1 signifies emergency call, phone numbers in the first to third entry of contact list will be dialed until a successful call is made, and SMS of ‘SOS’ will be sent to the said phone numbers;
closing key value of 2 signifies enter editing mode;
closing key value of 3 signifies power on/off function realized through power on/off program;
closing key value that is neither 1, 2 nor 3 signifies null value;

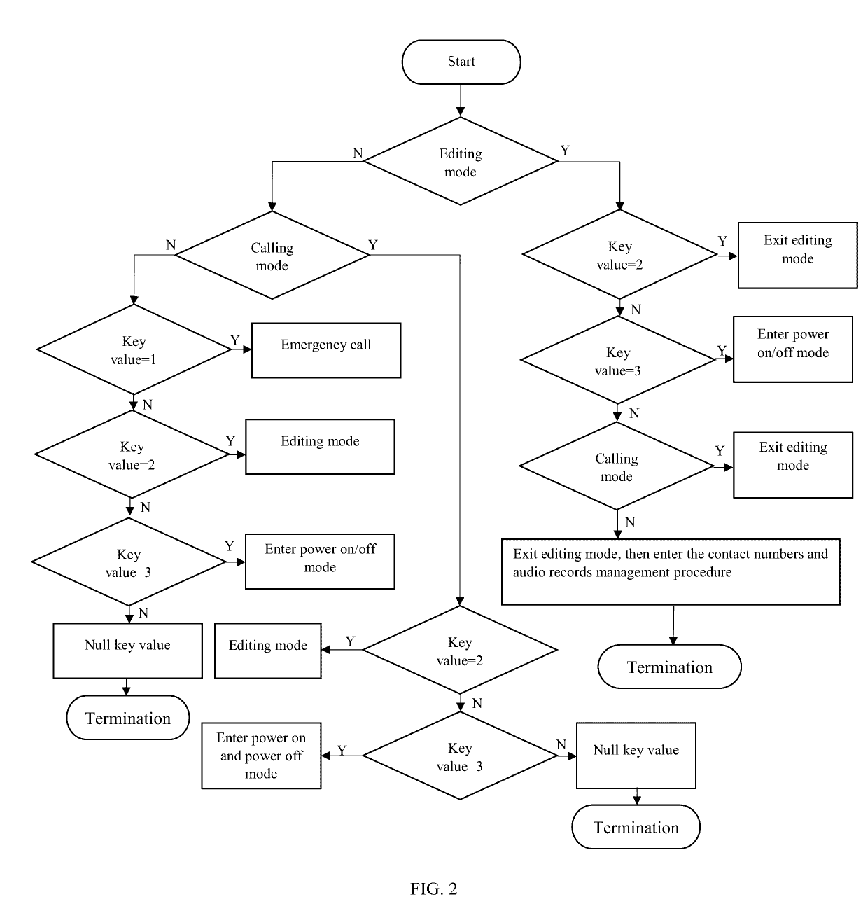

5: while neither in editing mode nor idle mode, any closing key value signifies null value; without breaking the above rules, the ‘closing key value processing procedure’ can be set as desired, while the present invention preferably selects the ‘closing key value processing procedure’ as shown in FIG. 2:

(41) judging whether phone is under editing mode, if yes, skip to step (42); otherwise, skip to step (44);

(42) exit editing mode when closing key value is 2, while enter power on/off mode when closing key value is 3; otherwise, skip to step (43);

(43) judging whether the phone is under calling mode, if yes, any closing key value that is neither 2 nor 3 signifies exit editing mode; otherwise, any ‘closing key value’ that is neither 2 nor 3 signifies exit editing mode and enter the ‘contact numbers and audio records management procedure’;

(44) judging whether the phone is under calling mode, if yes, enter editing mode when the closing key value is 2, while enter power on/off mode when the closing key value is 3; otherwise, enter emergency calling mode when the closing key value is 1, enter editing mode when the closing key value is 2, while enter power on/off mode when the closing key value is 3; the emergency contact numbers in the said emergency contact mode are stored as the first to third phone numbers in the contact list, associated with the ‘key values’ 1 to 3 respectively; in the emergency calling mode, the device will dial the said first through third phone numb ers according to the numerical order until a success phone call is made, moreover, a SMS of ‘SOS’ will be sent to each of the said emergency contact numbers.

(III) Phone Numbers and Audio Records Management Procedure

In the present embodiment, the rules to phone numbers and audio records management procedure are as follows:

1: while when the releasing key value entered before exiting editing mode is null value (any releasing key value that is larger than 12), exit phone numbers and audio records management procedure and enter idle mode.

2: while when closing key value is 1;
A: if a releasing key value had been entered earlier, store the input phone number to the nearest empty entry in the contact list;
B: if no releasing key value had been entered earlier and the time elapsed after end an incoming call exceeded 30 seconds, exit phone numbers and audio records management procedure and enter idle mode;
C: if no releasing key value had been entered earlier and the time elapsed after end an incoming call is within 30 seconds, store the incoming phone number and input audio record to the nearest empty entry in the contact list;
3: closing key value of 2 and 3 are null values;
4: while when closing key value is larger than 3;
A: if a releasing key value had been entered earlier, store the input phone number and audio record to the entry in the contact list with entry number equals to the closing key value (the input phone number must have number of significant digit larger than 2, otherwise, exit phone numbers and audio records management procedure and enter idle mode);
B: if no releasing key value had been entered earlier and the time elapsed after end an incoming call exceeded 30 seconds, store the input audio record to the entry in the contact list with entry number equals to the closing key value without storing the phone number;
C: if no releasing key value had been entered earlier and the time elapsed after end an incoming call is within 30 seconds, store the incoming phone number and input audio record to the entry in the contact list with entry number equals to the closing key value;

without breaking the above rules, the ‘phone numbers and audio records management procedure’ can be set as desired, while the present invention preferably selects the ‘phone numbers and audio records management procedure’ as shown in FIG. 10:

(431) judging whether closing key value is 1, if yes, skip to step (432); otherwise, skip to step (434) when closing key value is greater than 3;

(432) judging whether a releasing key value had been entered before exit editing mode, if yes, store the ‘releasing key value’ as the phone number in the second field of the empty entry with the smallest entry number in the contact list, then start audio recording until the key is released and store in the third field of the said entry; otherwise, skip to step (433);

(433) judging whether the phone is in the status where the time elapsed after ending an incoming call is shorter than time 30 seconds, if yes, store the incoming call phone number in the second field of the empty entry in the contact list with the smallest entry number, then start audio recording until the key is released; then store the input recording in the third field of the said entry; otherwise, exit ‘contact numbers and audio records management procedure’, then enter idle mode;

(434) judging whether a releasing key value had been entered before exit editing mode, if yes, store the ‘releasing key value’ as the phone number in the second field of the entry in the contact list with the entry number corresponding to the closing key value, then start audio recording until the key is released and store in the third field of the said entry; otherwise, skip to step (435);

(435) judging whether the phone is in the status where the time elapsed after ending an incoming call is shorter than time 30 seconds, if yes, store the incoming call phone number in the second field of the entry in the contact list with the entry number corresponding to the closing key value, then start audio recording until the key is released; then store the input recording in the third field of the said entry; otherwise, start audio recording until the key is released and store in the third field of the entry in the contact list with the entry number corresponding to the closing key value.

The method to operate phone using a single key provided by the present invention also have the function of region recognition, in which the phone numbers in the contact list with entry number of 1 to 3 are granted the permission to control the said phone through SMS through the method as follows:
First step: After receiving learning command through SMS, phone will store the positioning data of the base stations it passes during the learning period in the FLASH memory.
Second step: After receiving ‘In’ command through SMS, if the phone enters the base station it passed during the learning period, SMS containing ‘Inside’ will be sent to the phone numbers in the contact list with entry number of 1 to 3; After receiving ‘out’ command through SMS, if the phone leaves the base stations it passed during the learning period, SMS containing ‘Outside’ will be sent to the phone numbers in the contact list with entry number of 1 to 3.

The method to operate phone using a single key provided by the present invention also have the function of location positing: After receiving positioning query command from the phone numbers in the contact list with entry number of 1 to 3, the phone will reply with the positioning data of the current base station through SMS automatically.

The method to operate phone using a single key provided by the present invention also have the function of guardian monitoring: When the phone is set to guardian monitoring mode through SMS, the phone will automatically pick up calls from the phone numbers in the contact list with entry number of 1 to 3, where the caller is able to hear the surrounding sound around the said phone clearly.

The method to operate phone using a single key provided by the present invention also have the function of speech recognition: while in ringing mode, the CPU of the said phone recognizes the speech from the microphone and picks up the call with speakerphone mode when the speech ‘Hello’ is identified.

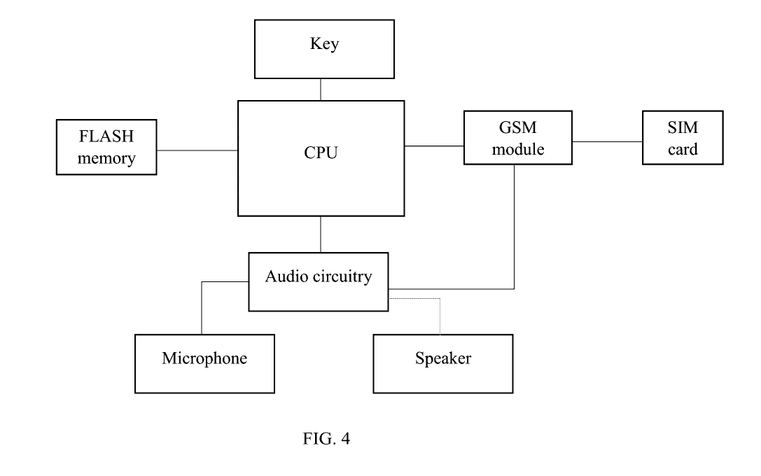

As shown in FIG. 4, the present invention also provides a device of single-key mobile phone, utilizing the chip Atmega328, the FLASH memory, the key and audio circuit, the chip SIM900A, the microphone, the speaker and the SIM card, where the said CPU is used for counting the number of times of the key closing and releasing action and the interval, as well as calling and storing the contacts and the recordings in the FLASH memory, driving the GSM module to carry out wireless communication, and controlling the audio circuitry to perform recording and recording playback; the voice signal generated by said microphone will be input into the GSM module after being processed by the power amplifier of the audio circuit and the anti-interference module; the voice signal received by said GSM module will be input into the speaker to carry out voice playback after being processed by the anti-interference module of the audio circuit and the power amplifier; said SIM card and GSM module is connected to provide verification of identification of the network users. Since one a single key is required, which can be either installed on the phone or a Bluetooth device that is connected to the phone through wired/wireless communication.

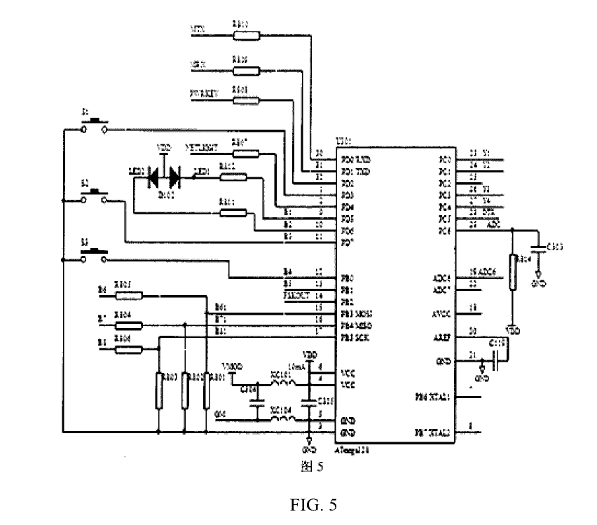

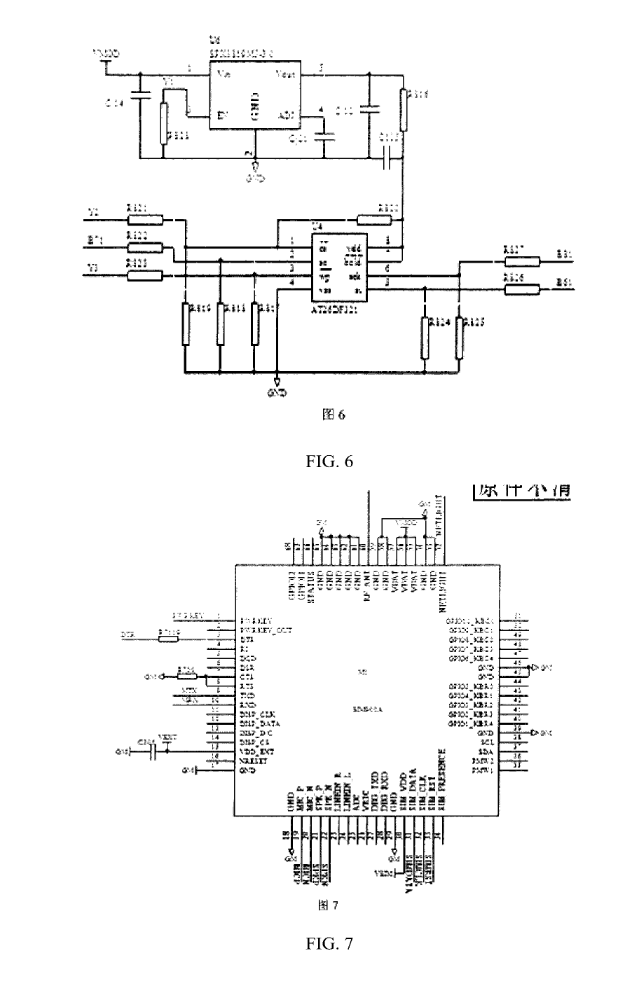

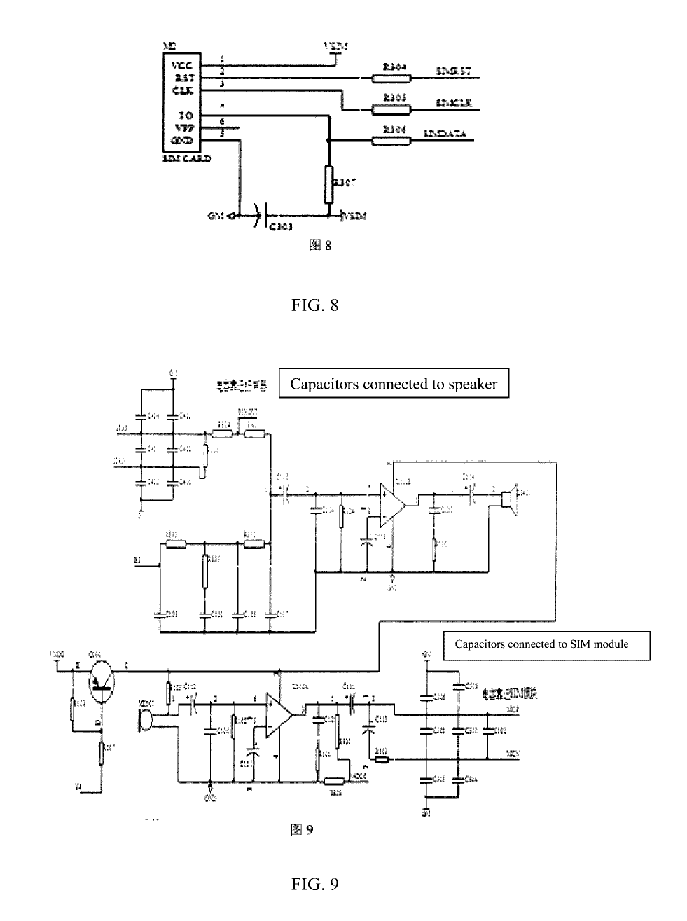

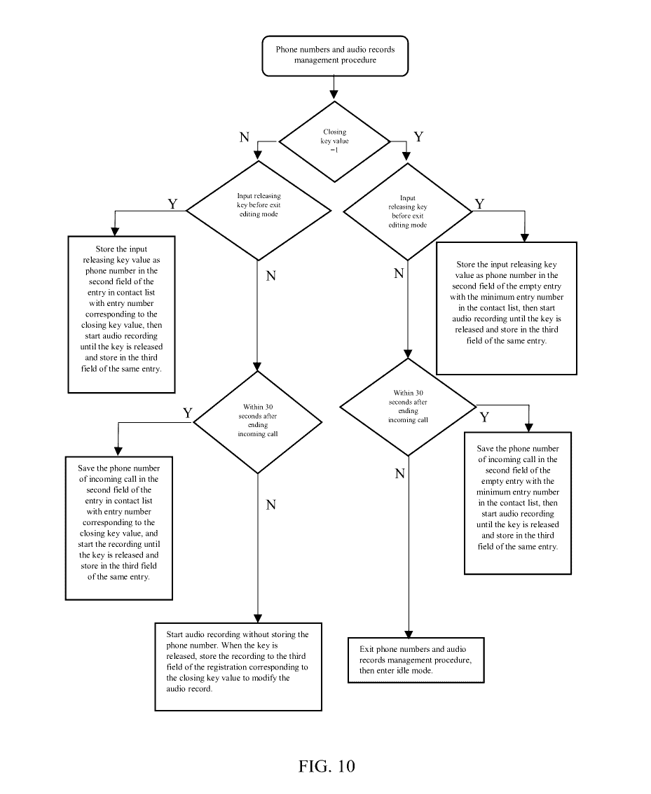

As shown in FIG. 5 and FIG. 6, the FLASH memory is connected with the pins Y2, Y3, B61, B71, B81 of the chip Atmega328; as shown in FIG. 5 and FIG. 7, the chip SIM900A is connected with the pins NETLIGHT, MTX, MRX, PWRKEY of the chip Atmega328; as shown in FIG. 5 and FIG. 9, the audio circuit is connected with the pins B5, Y4, ADC6 of the chip Atmega328; as Shown in FIG. 8 and FIG. 9, the speaker section of the audio circuit is connected with the pins SPKP, SPKN of the chip SIM900A through the anti-interference module composed of 6 capacitors, while the microphone is connected with the pins MICP, MICN of the chip SIM900A through the anti-interference module composed of 7 capacitors.

The foregoing description is only the preferable embodiment of the present invention, it should be noted that: for the technicians of the field of the invention, on the premise without leaving away from the principle of the invention, a number of improvements and retouching could be made, but these improvements and retouching should also be considered as the protection scope of the present invention.

What is claim is:

1. A method to operate phone using a single key, characterized in that: the method is realized with a single key through the following steps:
(1) when the key is just closed, plus 1 to the ‘key value’,
(2) judging if the key closing time is less than t1, if yes, skip to step (3); otherwise, skip to step (4);
(3) judging if the key releasing time is less than t2, if yes, skip to step (1); otherwise, store the key value as the ‘releasing key value’, exit the key value forming process, and trigger the ‘releasing key value processing procedure’;
(4) store the ‘key value’ as the ‘closing key value’, exit the key value forming process, and trigger the ‘closing key value processing procedure’;
(5) the key statues enters idle mode and the key value is set to zero;
wherein the said step (3), when dialing the phone number associated with the ‘releasing key value’, each time when the key is pressed, a prompt tone corresponding to the stored phone number associated with the ‘releasing key value’ will be played once. To dial the prompted number, do not press the key after the prompt tone, a call will be made automatically after time t2 to the corresponding phone number; otherwise, continue pressing the key within time t2 until the desired number is reached.

2. A method to operate phone using a single key as in claim 1 in which the said t1=1.7 s;
t2=1.7 s.

3. A method to operate phone using a single key as in claim 1 in which in the said step (1), each time when the key is pressed, the prompt tone relating to the stored contact number corresponding to the ‘key value’ will be played once.

4. A method to operate phone using a single key as in claim 1 in which in the said step (3), the ‘releasing key value processing procedure’ includes the following steps:
judging whether the phone is under editing mode, if yes, ‘releasing key value’ is an integer ranging from 1 to 12 which corresponds to the keys 1, 2, 3, 4, 5, 6, 7, 8, 9, 0, #, and ‘dial/pickup’ on a typical phone pad;
judging whether the phone is under idle mode and is not under editing mode, if yes, dial the phone number corresponds to the ‘releasing key value’,
judging whether the phone is under calling mode, if yes, any ‘releasing key value triggers ‘end call’,
judging whether the phone is under the status where a phone number has been successfully dialed but is not picked up by the receiver, if yes, any ‘releasing key value’ triggers ‘end call’;
judging whether the phone is under ringing mode, if yes, ‘releasing key value’ equals one triggers ‘pick up call’, while ‘releasing key value’ equals two triggers end call.

5. A method to operate phone using a single key as in claim 4 in which the said procedure for judging of whether the phone is under editing mode also includes the following steps:
judging whether the phone is under calling mode, if yes, send the dual tone multi-frequency signal corresponds to the ‘releasing key value’;
judging whether the ‘releasing key value’ corresponds to ‘dial/pickup’, if yes, dial the phone number corresponds to the ‘releasing key value’ stored right before the current ‘releasing key value’; otherwise, store the current ‘releasing key value’.

6. A method to operate phone using a single key as in claim 4 in which in the said procedure for judging of whether the phone is under ringing mode, when the phone is under ringing mode, if the incoming call is made from a phone number stored in the device, the ringing tone will be the prompt tone corresponds to the said phone number; otherwise, the ringing tone will be a default sound.

7. A method to operate phone using a single key as in claim 4 in which in the said procedure for judging of whether the phone is under ringing mode, when the phone is under ringing mode, determine whether to pick up the call through speech recognition.

8. A method to operate phone using a single key as in claim 1 in which in the said step (4), the ‘closing key value processing procedure’ includes the following steps:
when the phone is under editing mode, includes the following steps:
judging whether the ‘closing key value’ is 2 or 3, if yes, when the ‘closing key value’ is 2, exit editing mode, whereas when the ‘closing key value’ is 3, enter power on\off mode;
judging whether the phone is under calling mode and the ‘closing key value’ is neither 2 nor 3, if yes, any ‘closing key value’ that is neither 2 nor 3 triggers the phone to exit editing mode; otherwise, any ‘closing key value’ that is neither 2 nor 3 triggers the phone to exit editing mode and enter the ‘contact numbers and audio records management procedure’;
when the phone is not under editing mode, judging whether the device is under calling mode, if yes, enter editing mode when the ‘closing key value’ is 2 and enter power on\off mode when the ‘closing key value’ is 3; otherwise, enter emergency calling mode when the ‘closing key value’ is 1, enter editing mode when the ‘closing key value’ is 2, and enter power on\off mode when the ‘closing key value’ is 3.

9. A method to operate phone using a single key as in claim 8 in which in the said emergency calling mode, the emergency contact numbers are stored as the first to third phone numbers in the contact list, associated with the ‘key values’ 1 to 3 respectively; in the emergency calling mode, the device will dial the said first through third phone numbers according to the numerical order until a success phone call is made, moreover, a text message seeking for help, for example ‘SOS’, will also be sent to each of the said emergency contact numbers.

10. A method to operate phone using a single key as in claim 1 in which each entry in the said contact list contains 3 field where the first field is used to store the entry number that corresponds to the physical location of the said entry in the FLASH memory, the second field is used to store the phone number, and the third field is used to store the audio record of customized prompt tone.

11. A method to operate phone using a single key as in claim 8 or claim 10 in which the said ‘contact numbers and audio records management procedure’ includes the following steps:
judging whether the ‘closing key value’ is one, if yes, execute the procedure to determine whether there is input to the ‘releasing key value’ before exiting editing mode, if there is input to ‘releasing key value’ before exiting editing mode, store the ‘releasing key value’ as the phone number in the second field of the empty entry with the smallest entry number in the contact list, then start audio recording until the key is released and store in the third field of the said entry; if there is no input to ‘releasing key value’ before exiting editing mode, execute the procedure to determine whether the phone is in the status where the time elapsed after ending an incoming call is shorter than time t3, if yes, store the incoming call phone number in the second field of the empty entry in the contact list with the smallest entry number, then start audio recording until the key is released and store in the third field of the said entry, otherwise, exit ‘contact numbers and audio records management procedure’, then enter idle mode;
judging whether the ‘closing key value’ is larger than 3, if yes, execute the procedure to determine whether there is input to the ‘releasing key value’ before exiting editing mode, if there is input to ‘releasing key value’ before exiting editing mode, store the ‘releasing key value’ as the phone number in the second field of the empty entry with the smallest entry number in the contact list, then start audio recording until the key is released and store in the third field of the said entry; if there is no input to ‘releasing key value’ before exiting editing mode, execute the procedure to determine whether the phone is in the status where the time elapsed after ending an incoming call is shorter than time t3, if yes, store the incoming call phone number in the second field of the empty entry with the smallest entry number in the contact list, then start audio recording until the key is released and store in the third field of the said entry, otherwise, only start audio recording until the key is released and store in the third field of the entry with entry number equals to the ‘closing key value’ while make no modification to the phone number in the second field of the said entry;
judging whether the input to the ‘releasing key value’ before exit editing mode corresponds to null value, if yes, exit ‘contact numbers and audio records management procedure’, then enter idle mode.

12. A method to operate phone using a single key as in claim 1 in which the said key is installed on a phone or a device connected to phone through means of wired/wireless communication.
